(19) United States
(12) Patent Application Publication
(10) Pub. No.: US 2003/0041121 A1
(43) Pub. Date: Feb. 27, 2003

(54) On-line system for providing assistance to students

(76) Inventor: Chadd B. Levine, Huntingdon Valley, PA (US)

Correspondence Address: William H. Eilberg, Esq., 420 Old York Road, Jenkintown, PA, 19046, US

(21) Appl. No.: 09/935,404

(22) Filed: Aug. 22, 2001

(51) Int. Cl. G06F 15/16; G09B 25/00

(52) U.S. Cl. 709/219; 709/203; 434/365

(57) ABSTRACT

An on-line system enrolls students and prospective students into an electronic community. Members can contact other members on-line, so that prospective students, for example, can obtain information about particular colleges or universities from other students. Students can obtain information about specific courses from others who have taken the courses. The system includes a repository of papers and assignments, donated by students, which can be used as a reference tool by other students. The system also provides social assistance, enabling students to find other students sharing similar interests and backgrounds. The system also facilitates the buying and selling of used merchandise by students, and provides a method by which each student can conveniently maintain a scrapbook pertaining to his or her college experience. The system also provides a personalized set of discount coupons, tailored to the needs of a particular student.

### BACKGROUND OF THE INVENTION

The present invention relates to the field of higher education, and includes a system and method for providing various kinds of assistance to students.

College students, or prospective college students, must make decisions concerning what college to attend, what courses to take, and what professors to select. These are important decisions, but they are often made unintelligently, as the student often has relatively little specific information available. For example, for any particular course, the only information usually available to the student is a brief description in the course catalog. It is possible for the prospective student to do more intensive research, such as by interviewing students and faculty, but these steps are very time consuming, and are often entirely impractical.

College students enrolled in a particular course are faced with other kinds of challenges. The college environment is intended to foster independence, but it also can isolate the student just when he or she needs help. For example, the answers to a homework assignment, or the answers to a sample test question, may not be available in a textbook, and a student may have difficulty mastering the material on his or her own. It is possible for a student to arrange an in-person meeting with the professor, but this approach is cumbersome, and not always possible on short notice. Moreover, not every professor is equally approachable or available.

Some information about colleges has been made available through the Internet. For example, the web site of campusticket.com provides information about a variety of colleges and universities. The present invention, however, is an on-line system which goes much further in providing very specific assistance to students in solving the abovementioned problems and others. The present invention fulfills a multiplicity of needs which are especially felt by students at academic institutions.

### SUMMARY OF THE INVENTION

The present invention is an on-line system which preferably works through the Internet. The members of the system form an electronic community, including students, prospective students, and alumni, who become linked, through one or more host computers, to information pertaining to academic institutions.

In one aspect of the invention, users can contact students or former students who are taking, or who have taken, a particular course, so as to obtain information about that course. Users can therefore make intelligent decisions about whether to enroll for a course, and can obtain assistance with problems encountered after enrollment.

In another embodiment, users can obtain tutoring services from other members of the community, preferably from others who are taking, or who have taken, particular courses.

The present invention also allows students taking a particular course to contact other students enrolled in the same course, so as to form on-line study groups.

The invention also provides a variety of chat rooms, the memberships of which are determined by various criteria. One such chat room is based on fraternity membership; a user can chat with other members of the same fraternity. Another chat room comprises residents in a particular dormitory, allowing the user to chat with others living in the same building. Another chat room allows a user to visit with others who come from the same city or town. Still another chat room allows a user to speak with other members who are majoring in a particular field. Finally, the system provides a general chat room, in which a user can communicate on-line with any other member of the electronic community.

The invention also provides reference materials for its users. For example, the host computer includes directories of students and alumni which can be retrieved according to city or town of origin, or according to field or profession, allowing users to contact other members according to these selected criteria.

An important aspect of the invention, in the category of reference materials, is a database of papers, such as research papers, assignments, and lecture notes, stored in the host computer, and indexed according to subject matter or course. The database is accessible by students who need help with particular courses, or who have missed a particular lecture.

The host computer may also include a database of alumni-employers who are seeking to hire graduates of a particular academic institution.

Another aspect of the invention is the distribution of news and notices to students. Information about particular courses, such as cancellations or changes in assignments, can be provided to students on-line. Also, information about general college events, and other events, is similarly made available.

The invention preferably also includes various other features that fulfill the needs of many students. For example, the system may be programmed to conduct auctions of used goods, such as books, furniture, and automobiles, which many students are interested in buying or selling. The system may also include an auction for tickets to various cultural or sporting events.

Another feature of the invention is the on-line assembly of a scrapbook. Each participating student may upload photographs and other memorabilia, for storage in the memory of the host computer. If such items are regularly uploaded during a four-year period, the result is a substantial scrapbook that can be later downloaded to preserve the memories from the college experience.

Still another miscellaneous feature is the ability of the system to provide discounts and coupons, originating with businesses serving academic communities, to the members of the electronic community. A student may create a personalized coupon page by designating only those businesses in which the student may be interested, so that coupons are targeted to those students who are most likely to use them.

The invention therefore has the primary object of providing an on-line system for assisting students, prospective students, and alumni of academic institutions.

The invention has the further object of providing information and/or tutoring, to students and prospective students about specific courses, by enabling students to contact others who have taken, or who are taking, such courses.

The invention has the further object of providing both academic and social assistance to students of academic institutions.

The invention has the further object of providing a repository of papers, assignments, and lecture notes, indexed to particular courses, to be accessed by students who are taking such courses.

The invention has the further object of enhancing the ability of students and alumni to communicate with other students and alumni who come from the same town, or who share an interest in a particular academic field.

The invention has the further object of providing an on-line system which provides news and information, on a targeted basis, to students.

The invention has the further object of enabling students to buy and sell used goods such as books or furniture.

The invention has the further object of enabling students to keep a scrapbook containing memorabilia of college experiences.

The invention has the further object of providing targeted advertising to students, from businesses located near particular academic institutions.

The reader skilled in the art will recognize other objects and advantages of the present invention, from a reading of the brief description of the drawings, the detailed description of the invention, and the appended claims.

### BRIEF DESCRIPTION OF THE DRAWINGS

FIG. 1 provides a block diagram showing a host computer connected to a plurality of computers operated by students, according to the present invention.

FIGS. 2a through 2d provide block diagrams illustrating the various features programmed into the host computer, according to the present invention.

### DETAILED DESCRIPTION OF THE INVENTION

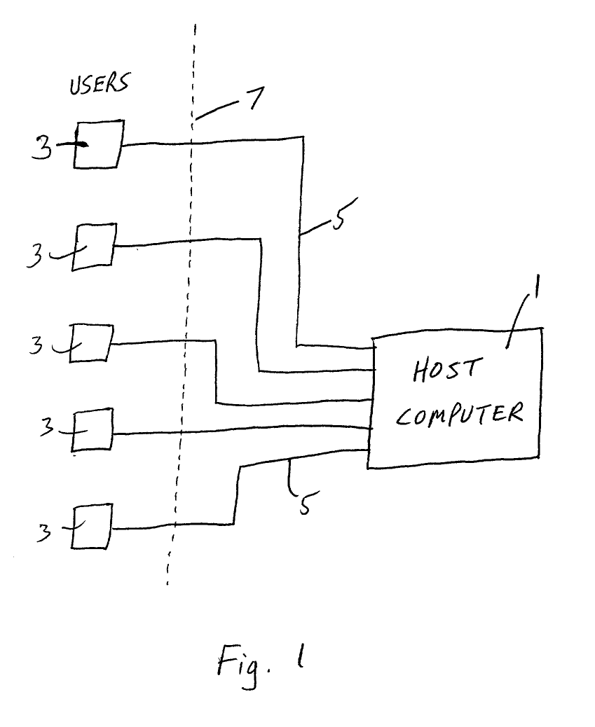

FIG. 1 illustrates the general configuration of the present invention, showing the relationship between a host computer, which stores information available to users of the system, and the users themselves. Host computer 1 is preferably linked to a plurality of computers 3, each of the computers 3 being associated with a particular user. The connection between the host computer and the computers 3 of the various users is preferably through the Internet.

In this specification, the plurality of users is often called the “electronic community”. In general, the members of the electronic community may include students, prospective students (including high school students), professors, teaching aides, teaching assistants, administrators, and/or former students. The one essential characteristic that defines the members of the electronic community is that they have some present, past, or prospective affiliation or connection with an academic institution.

The Internet connections are symbolically indicated by lines 5, and these could be any known types of connection, such as telephone lines, cable modems, DSL connections, or other connections. While the preferred means of connecting the host to the users is through the Internet, the invention is not limited to any one means of connecting, and the invention could be practiced with alternative communication schemes. Dotted line 7 represents the fact that, in general, the users 3 may be distant from the host computer.

Although a single host computer is shown in FIG. 1, the functions of the host computer could be divided among a plurality of computers. Different databases could reside in the memories of different computers, linked together. The diagram of FIG. 1 is intended to include this alternative. Thus, although this specification will speak of the “host computer” in the singular, it is understood that this term allows for the possibility that the data processing could be distributed among more than one computer, quite possibly in more than one location.

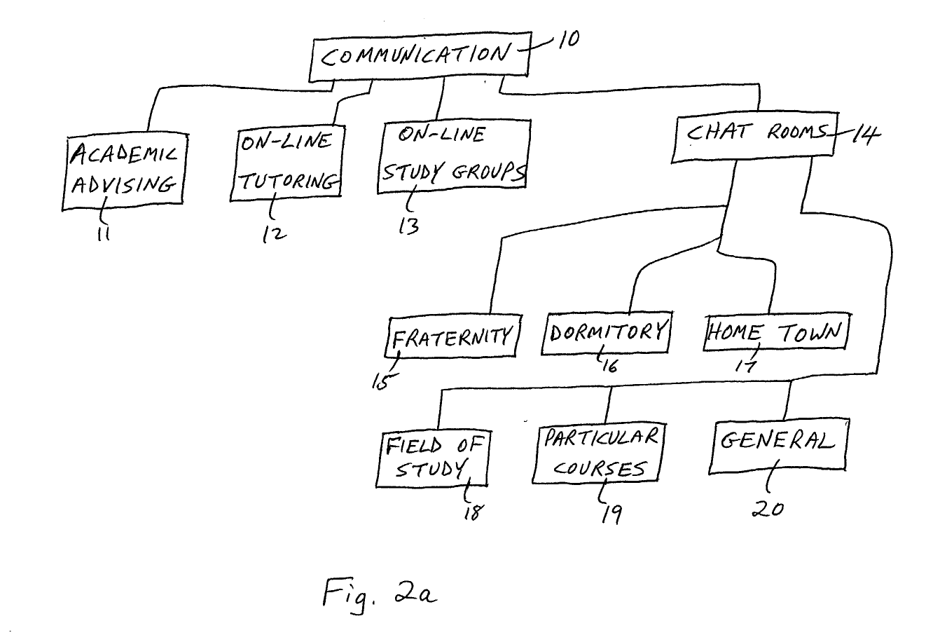

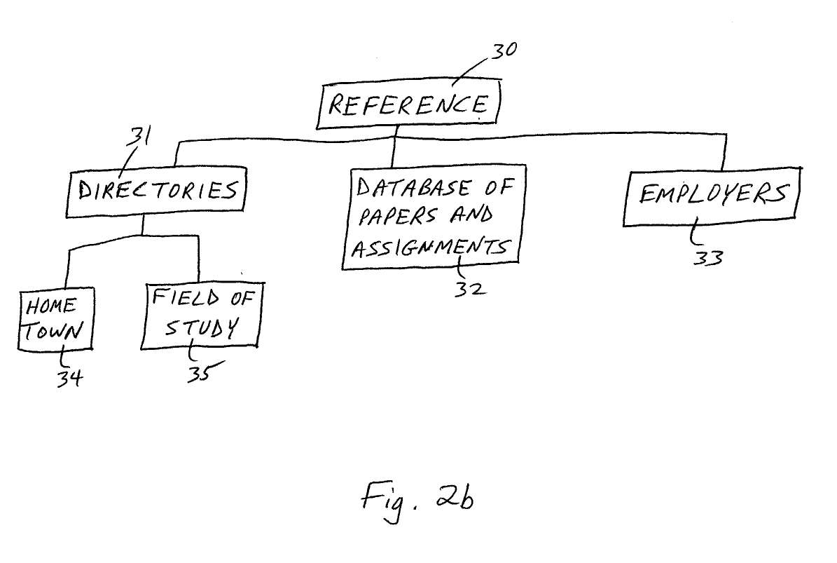

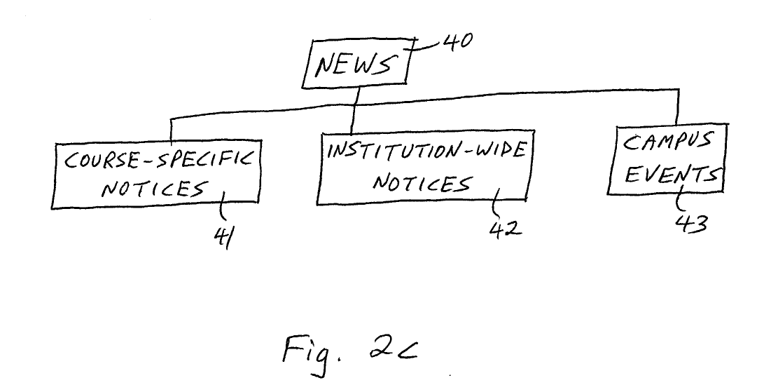

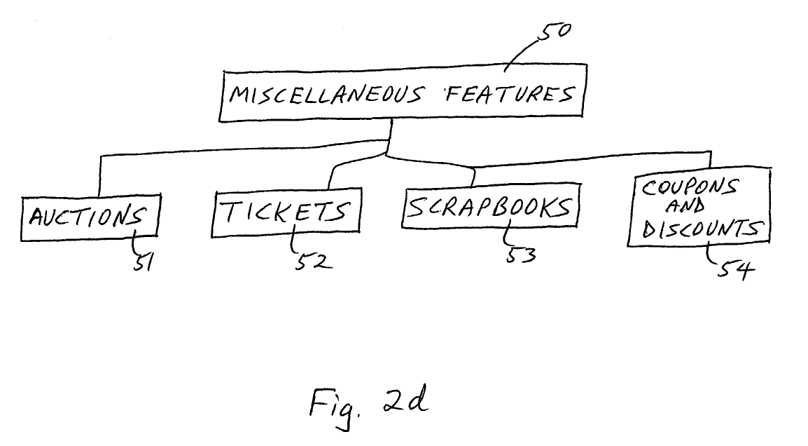

FIG. 2 illustrates the functions programmed into the host computer, according to the present invention. These functions are divided into the broad categories labeled communication (block 10), reference (block 30), news (block 40), and miscellaneous features (block 50). Each of these categories is further subdivided as will be explained below. In brief, the category of “communication” refers to the ability of students to communicate with other members of the electronic community, either by electronic mail (email) or in real-time. The category of “reference” indicates a repository of written information available to the student. The category of “news” refers to the ability of the system to provide students with on-line notices. The category designated “miscellaneous features” refers to various other functions that are designed to assist students in different ways.

The various functions performed by the system, in each category, are described in detail below.

1. Communication

a. Academic Advising

This function is represented by block 11. This service enables a user, namely a student or prospective student, to contact other students, at a selected institution, who have already taken a course which the user is considering. Thus, the user can obtain valuable information on a particular course and/or professor before deciding whether to register for the course. For example, the user can obtain the comments of other students about whether a particular professor is a good teacher, and whether he or she is a difficult grader.

In operation, the user indicates, in a suitable block provided on a display, the course of interest, and the institution at which the course is offered. The system then provides names, and pertinent contact information, of one or more students, and/or alumni, who are members of the electronic community, and who are taking or who have taken that course. The system can be programmed to indicate whether each person is currently taking the course, or whether such person has taken a prior version of the course in the past. The user can then contact these persons, either by email, by mail, or by telephone. The system is preferably programmed such that the user can click on a name, and be immediately directed to an email template, with which the user can send a message. The user could also attempt to reach such persons through the chat rooms provided by the system (described below).

Thus, the user gains easy access to a source of detailed information about a particular course or professor, including information that would not be found in a course catalog.

The above-described procedure is not limited to use with respect to specific courses, but can also be used to obtain more general information about an academic institution. Thus, a prospective student can contact students currently attending a selected institution, and obtain general information about that institution, from the students' perspective. Instead of relying solely on brochures, catalogs, or university representatives, the prospective student can easily find out what current students really think about the school. In addition, college-bound high school students may use this feature to make friends and contacts before even arriving on campus.

The specific interface used by the system to receive inputs from users, and to display output to users, can take many different forms. The invention is not limited to any particular style of screen display seen by the users. The latter statements are true with regard to all of the functions described in this specification.

b. On-line Tutoring

This function is represented by block 12. This service offers students the ability to obtain academic assistance from other students who have taken, or who are taking, a particular course. The service can be provided in a chat room format, with student and tutor being on-line at the same time. Alternatively, the tutoring could be conducted by telephone, by email, or in person.

In operation, the student indicates the course in which tutoring is desired, and the institution attended, and the system responds with the name and contact information of one or more potential tutors. Alternatively, the student need not specify the institution, since the system will know the institution associated with each student, based on the information provided by the student upon joining the community. Moreover, since the tutoring may be done electronically, it is not even necessary that the student and tutor attend the same institution.

The names of potential tutors can comprise names of students who have indicated their willingness to act as tutors in specific courses. The latter information is obtained from members of the electronic community at the time they join the system.

The tutoring could be done on a voluntary basis, or the parties could make their own payment arrangements. In still another alternative, the rates could be set by the operator of the system, with the system retaining a percentage of the payments to cover expenses.

As noted above, some or all of the tutoring may be conducted by email, and the tutoring can be provided by more than one person. The partial automation of the tutoring process can be accomplished as follows. A student posts a question pertaining to the subject matter of a particular course, the question being stored in the memory of the host computer. The system then automatically sends this question, via email, to some or all students who have taken the course, or who are presently taking the course. The system could also restrict the distribution of such questions to students who have indicated their willingness to act as tutors. The respondents can then answer the question, if they wish, by email, or they can contact the questioner by other means.

The system can also be programmed to display a directory of persons, and contact information, once the question has been entered, enabling the user to send individualized email messages to such persons. To the extent that the user has previously entered his or her courses, the system can display the pertinent lists of potential tutors more rapidly.

c. On-line Study Groups

This function is represented by block 13. In this service, the study group takes the form of an electronic chat room in which the participants are students who are all taking the same course. The user can enter this chat room at any time. The chat room is a means for providing real-time on-line communication among various members of the system. The techniques for providing on-line chat rooms are well known in the art, and do not themselves form part of this invention. In the on-line study groups represented in block 13, students can assist each other by discussing the subject matter of a particular course and answering the questions posed by the others. This function can be structured such that each study group is conducted among students attending the same academic institution, or it can be structured to allow study groups having members taking similar courses at different institutions. In either case, each of the chat rooms symbolized by block 13 is limited to persons taking a particular course.

In operation, the student indicates the course of interest, and, depending on the alternative chosen, the institution attended. The system then directs the user to a chat room in which the participants are students taking that same course. The studying is then conducted by computer, without requiring the student to leave his or her dormitory. To the extent that the study groups span more than one institution, each student receives the benefit of interacting with other students from possibly distant locations, thereby increasing the likelihood of a mutually beneficial exchange of information.

d. General Chat Rooms

This function is symbolized generally by block 14, and more specifically by the sub-blocks connected to block 14.

The system allows the user to enter various chat rooms, the participants of which are determined by the criteria discussed below. The on-line study group discussed above is a special case of a chat room, insofar as it is related to specific courses or subject areas. The chat rooms symbolized by block 14 are more general in scope.

One type of chat room, symbolized by block 15, is based on fraternity membership. The user may join a chat room whose participants are members of a particular fraternity or sorority. The system may be programmed to allow only members of the fraternity or sorority to join the chat room, or it could be programmed to allow others. The system may also be programmed to allow only members on some occasions, and to allow non-members on other occasions. If the fraternity or sorority is national in scope, this chat room can allow the user to communicate with other members of the same organization throughout the nation or the world.

Thus, depending on the specific alternative chosen, the user can be prompted to enter the name of his or her fraternity or sorority, and the system will allow the user to enter the electronic chat room associated with the selected organization. To the extent that it is desired to limit the user to chat rooms based on members at a particular institution, the system can direct the user to the correct chat room automatically, because, in the preferred embodiment, the system already knows, from the registration process, the name of the academic institution attended by each student.

Another type of chat room, symbolized by block 16, is based on residence in a particular dormitory. In this chat room, the user may enter on-line discussions with others who live in the same building or other residential facility. In this way, a user may develop friends who, even though they live in the same building, might have remained unknown to the user. Membership in this chat room is therefore not based on membership in a particular class or course, but is solely determined by who lives in a certain building or buildings.

Another chat room, symbolized by block 17, allows a user to contact members of the electronic community who come from the same state, city, or town as the user. In this way, the user can meet others who attend the same institution, but who come from the same locality. The system can also be programmed to allow the user to enter a chat room comprising all members who come from a given location, regardless of the institution attended.

Still another chat room, symbolized by block 18, allows participants to speak with others who are involved with a selected academic field of study or profession. This feature allows the user to interact with others in his or her field, or prospective field. It is especially helpful to students who are still deciding on a major field of study. As before, the chat rooms can be limited to those associated with a particular institution, or they can allow contact with others in the same field, regardless of their institution. In all cases, a user can gain valuable, practical information from others in particular fields, and especially information that is not readily obtainable from books or catalogs.

Still another chat room, symbolized by block 19, allows students to communicate on-line with other students who are taking a particular course at the same time. Block 19 therefore represents, in the most general case, a plurality of separate chat rooms, each being associated with a particular course, and each such chat room being limited to students taking that particular course. The chat room can also be limited to those persons taking a particular course at a particular institution. To enter one of these chat rooms, the user must indicate a course, and the system then takes the user to the appropriate chat room.

Finally, the system provides a general chat room, symbolized by block 20, in which the participants can be any members of the electronic community.

2. Reference

a. Directories

This function is represented by block 31, which symbolizes the various directories available to users of the system.

One such directory is a directory of students and alumni who come from a particular state, city or town. The latter function is symbolized by block 34. A student, or prospective student, can thereby obtain the names and contact information for others who have attended a particular institution, and who come from the same geographical area as the user.

Another directory, symbolized by block 35, contains names of students and alumni who have majored in a particular field, and/or alumni who belong to a particular profession. The latter directory can be subdivided further, by providing the names of students currently taking a particular course at a particular institution. In all cases, the directories provide names of the participants, and pertinent contact information, which could include addresses, telephone numbers, email addresses, or any or all of the latter.

These directories can also be used by alumni to locate friends who have not been seen in years. Simply by entering the name of an institution, a user can quickly search through the database and obtain the most updated available information about various persons who attended that institution.

b. Database of Papers

Block 32 represents another important function of the present invention. The system includes a database containing papers and assignments, donated by the various members of the electronic community, to be shared with all participating members. The database is stored in the memory of the host computer(s). The name of the donor of each item, along with pertinent contact information, is preferably provided together with the text of the assignment or paper. Lecture notes may also be included in this database, so that students may obtain lecture notes for classes that have been missed.

The items in the database are preferably categorized by field, so a user can search within a particular field, to obtain papers, assignments, or lecture notes pertaining to that field. The search can be limited in other ways, such as by institution, or by course or professor. Since the contact information of the donor is provided, a user can contact the donor with more specific questions. The inclusion of lecture notes is an important feature, as it allows students to obtain important information that they may have missed. The documents obtainable from the database constitute a valuable resource for students.

The screen display which allows a user to obtain such reference materials may also include an option through which the user can donate materials to the database. By clicking on an appropriate link, the user signals the system that he or she wishes to upload a file for inclusion in the database. The uploading process can comprise a direct file transfer, if the document is already stored electronically, or it can be scanned by a scanner (provided by the user), transmitted to the host computer, and then stored in the memory of the host computer.

c. List of Employers

This function is represented by block 33. The system includes a list of employer-alumni who are interested in recruiting employees from a particular academic institution. Thus, through this database, a student at an institution can locate alumni who are hiring, or who represent companies who are hiring, graduating students from that institution. The display page associated with this function may also include a link which enables prospective employers to add their names to the list.

3. News

a. Information about Classes

The system is programmed with information about particular classes. This function is symbolized by block 41. This is a database which is preferably updated daily, and which contains important information about particular classes. For example, the notices in the database would include class cancellations, assignments, changes of location, etc. A student would simply enter an institution and class, in an appropriate block on a display, and would then obtain the latest bulletins pertaining to that class. In this way, the system functions as an electronic bulletin board, enabling students to obtain important and essential information without doing more than a brief search on a computer. The system allows a professor teaching a course to transmit important notices to the host computer, knowing that the notices will be retrieved only by those taking that course. It also allows each student to receive only those notices that pertain to him or her. In the preferred embodiment, it is not even necessary for a student to enter information about courses taken or the institution attended, because the system will have received this information when the student joined the community. Thus, the student can simply click on a link entitled “class notices” or the like, and be shown all pertinent notices.

b. General Notices by Institution

The same database could also include general notices, issued by the administration of a particular academic institution, as symbolized by block 42. The bulletin board function is therefore not limited to course-specific information, but can include notices of any kind which are distributed by an institution to all of its students. Again, this bulletin board does not require the student to leave his or her dormitory to see a particular notice. Posting notices on the database in this way provides a convenient way for students to see all pertinent notices, since the on-line database of notices constitutes a central repository for such items. In the preferred embodiment, the user can simply click on a link entitled “general notices” or the like, and be shown all items that relate to students at the institution attended by the user.

b. Campus Events

This function is symbolized by block 43. The system is programmed with information about campus events, and events scheduled in the vicinity of each institution. By using this feature, a student can learn about concerts, athletic events, parties, special lectures, or other events to be held at or near a particular academic institution. This feature works in the same way as the posting of general campus notices described above, except that these notices do not necessarily originate with the administration of the institution, and may pertain to events which take place outside the academic institution.

4. Miscellaneous

a. Auctions

The system is programmed to conduct on-line auctions among students, as symbolized by block 51. Students can use this feature to buy and sell items such as used furniture, books, automobiles, apparel, memorabilia, etc. The auctions are preferably conducted on a system-wide basis, so a student is not limited to conducting transactions with students at the same institution. The system enables a student to deal with any other student who is a member of the electronic community, on a nationwide or worldwide basis, thus increasing the chance that the student will find what he or she wants to buy, or that the student will find a buyer for what he or she wants to sell. Thus, the sellers can obtain money for property that is no longer needed, and are likely to receive more than if the items are sold through traditional channels. Also, buyers using this portion of the system are likely to obtain various items more cheaply than elsewhere. The auction is particularly useful for buying and selling used books, and for buying and selling furniture used in a dormitory room or apartment. Students occupy dormitory rooms and/or apartments for limited times, and it is thus often necessary to buy or sell used furniture from time to time.

The mechanics of operating an on-line auction are well known. The system is programmed to accept information, from users, concerning merchandise offered for sale. Other users may peruse the on-line listings of merchandise, and may submit bids for same. If a seller is satisfied with a bid, the seller can contact the buyer by email, using an address provided by the system, and the parties can consummate the transaction. The form of the on-line auction can be modified substantially, within the scope of the invention. What is novel about the auction of the present invention is that the participants are all affiliated with an academic institution, and that the present invention enables students to deal with other students at the same or at any other academic institution, in buying and selling various articles.

b. Tickets

The system is programmed to enable students to buy and sell tickets for all events sponsored by a particular academic institution. This function is symbolized by block 52. The transactions can be accomplished through an auction, and this function could therefore be programmed as a sub-feature of the auctions represented by block 51.

In the preferred embodiment, the tickets bought and sold on the on-line auction are “student-specified tickets”, i.e. tickets which bear a notation that they are not valid without student identification.

The system can be designed so that members of the general public may buy and sell tickets, including student-specified tickets, using the on-line auction of the present invention. To avoid the need for members of the public to register as members of the electronic community, the ticket auction can be provided on a web site which is separate from the main web site defining the other features of the system. A link can be provided in the main web site which allows members of the electronic community to transfer to the auction. Thus, both students and non-students may participate in the auction.

c. Scrapbooks

This feature is symbolized by block 53. A student has the opportunity to post various items to an electronic scrapbook. Such items may include photographs, concert programs, other printed matter, and other items. This feature would require the use of a scanner, or its equivalent, to convert the item to be stored into electronic form. The student would use the scanner to upload items into the memory of the host computer. Suitable prompts on the scrapbook screen enable the user to do so. In the preferred embodiment, any student can upload such items at any time, simply by clicking on an appropriate area of the screen. The uploaded items are stored in the memory of the host computer, and indexed against the identifying information about the student who provided them.

The scrapbook feature works best if a student regularly posts items from the beginning of the first year, to the end of the last year, at a particular institution. Upon graduation, the student will have accumulated a substantial scrapbook, capturing the memories of many events that would otherwise be forgotten.

The student may download and print the scrapbook at any time. The information would remain in the memory of the host computer for as long as the user remained a member of the electronic community. If the user wishes, the scrapbook can be displayed publicly on the web site, as an example of how to assemble such a scrapbook. One advantage of this function is that the system counters the tendency to lose or misplace items that may later be recognized as valuable memorabilia.

d. Coupons and Discounts

This feature is symbolized by block 54. Various businesses, located in or near the vicinity of a particular academic institution, may offer promotions, coupons, or discounts to students. Students at a particular institution may view such advertisements, and/or print out a discount coupon, for use at one or more of such businesses. A student can search for such advertisements and coupons by specifying a particular institution, and the system responds with all such advertisements indexed against that institution.

Another feature of the invention allows the student to create a personalized coupon page. The student identifies one or more businesses that the student wants to patronize, or that the student may consider patronizing. The system then provides a page of coupons that relate only to the businesses selected. The coupon page is updated from time to time. Each time the student selects the personal coupon page, the page is printed, in its most updated form. This system therefore allows the student to avoid sifting through hundreds of coupons, most of which are not of interest. The particular format of a coupon can vary considerably; the invention is intended to include all possible formats.

The system of the present invention clearly works best when a large number of students participate. The more participants in the system, the more likely that a student will find another participant who has taken a particular course, or who has a particular item to buy or sell, for example. Ideally, the present invention comprises an electronic community of students and alumni that spans the nation or the world.

In operating the system of the present invention, it is important to obtain, and update, information about each participant. Upon joining, each participating student will complete a profile form, which may be done on paper or on-line. The form may include contact information, such as name, address (both at home and at school), major or intended major, status (i.e. freshman, sophomore, graduate student, etc.), academic institution and location (if an institution has more than one location), and courses being taken during the semester. The information on courses taken should be updated each semester, and should preferably include information on the professor, section, time of the classes, etc. Thus, the system can keep a record of which participants have taken which courses. The system can also ask the participant if he or she is able and willing to serve as a tutor for other students. The information received from participants enables the system to categorize each participant in various ways, so as to retrieve the name of each participant in response to a query from another student, as described above.

### EXAMPLE 1

Sue Brown is planning to attend Boston University in the fall, and wishes to obtain information on professors before registering for her classes. Because she is a freshman, she has no idea of what to expect. Knowing that she has chosen the right professors and courses would significantly increase her level of comfort in her new environment. Having become a member of the electronic community described above, she visits its web site, and enters the name of her school. Then, she is asked to type in her major field or intended major field. (The latter steps may be omitted if the system has already received this information from her when she joined the electronic community.) The system then displays the names of persons attending Boston University and having the same major field. By clicking on a name, she obtains information about the person's academic profile, including course history, names of professors, and sections, as well as contact information. Sue can now send an email to this person, or to several such persons, asking questions and expressing concerns.

If she had wanted, Sue could have searched by course rather than by major. That is, she could have typed in the department, title of the course, and section, if applicable, and possibly the name of the professor. The system would respond with a list of students who have taken that course. Sue can then contact any of these persons by email.

While she is at the web site, Sue decides to look up the names of persons from her home town, so that she might possibly find someone she knows or someone she would be interested in meeting, who is attending, or who plans to attend, the same university. Unless the information is already in the system, Sue is prompted to type in her home town, and a list of students from that location appears.

### EXAMPLE 2

Sue is now a sophomore and is enrolled in a very difficult biology course. She needs to know some information that is critical to her success on an examination the following morning. She visits the web site, types in the department, title of the course, and the section. The system responds, almost instantly, with a list of students in that class, together with contact information. She calls a woman on the list, and finds out that she and two others are having a study session at that moment. Sue goes over to join them, but finds that they are having the same problem. Sue returns to the computer, and obtains the name of someone in a different section of the same class (or she could have found someone who has previously taken the class). She then calls this person and is able to find the answer to her question, which benefits both her and the other students in the study group.

The present invention therefore has many advantages. In general, the invention enables students to help other students, and to receive help from other students, in ways that would be impossible or extremely impractical without the present system. The invention helps students to survive and to succeed in the college or university environment. The system provides both academic and social assistance.

The academic assistance provided by the system enables students to ask questions of others who are taking, or who have taken, a particular course, not only during the registration period, when a student is considering whether to enroll in a course, but also after the student has enrolled. The invention is especially helpful in urgent situations, such as on the eve of an examination, or at a time that an important assignment is due. The invention enables students to obtain lecture notes for missed classes. In general, the ability to contact others taking the same class is an invaluable tool.

The invention also eases the adjustment process for new college students, by providing them with a medium for communication with other students. The invention enables students to locate other students who come from the same place, and provides an opportunity to obtain general advice from others who have attended a particular academic institution.

Thus, the invention has the effect of relieving stress and preventing or reducing depression, among students, by providing them with reliable information about courses and professors, and by providing them with social outlets. By enabling a student to learn about courses or professors, from those who have had the experience before, the invention eases the transition to the college or university environment.

In short, the present invention is intended to fulfill a wide variety of the special needs of students at academic institutions. Clearly, the more students who participate, the more efficiently the system works.

The invention can be modified in many ways. Clearly, a system can be built with any or all of the features represented in FIG. 2 and described above. The invention is intended to include any and all such combinations of features. These and other modifications, which will be apparent to those skilled in the art, should be considered within the spirit and scope of the following claims.

What is claimed is:

1. A method of providing on-line assistance to persons having an affiliation with an academic institution, comprising:
a) receiving information about a plurality of users, each of said plurality of users having an affiliation with an academic institution, and storing said information in a memory of a host computer, wherein said information includes data on courses taken by each of said plurality of users,
b) accepting a query, from one of said plurality of users, concerning a particular course at an academic institution, and
c) providing a name of at least one person who has taken or is taking said particular course at said academic institution, so as to allow said one of said plurality of users to contact said at least one person.

2. The method of claim 1, further comprising providing on-line tutoring to said users, the on-line tutoring being provided by a person whose name was provided in step (c).

3. The method of claim 1, further comprising forming an on-line study group having members including said one of said plurality of users and said at least one person found in step (c), and enabling on-line communication among members of the study group concerning the course specified in step (b).

4. A method of providing on-line assistance to persons having an affiliation with an academic institution, comprising:
a) receiving information about a plurality of users, wherein said users have an affiliation with an academic institution, and storing said information in a memory of a host computer,
b) accepting a request from one of said users for communication with others of said users, and
c) connecting said one of said users to others of said users so as to permit real-time on-line communication between said one of said users and said others of said users.

5. The method of claim 4, wherein step (b) comprises accepting a specification of a particular organization, and wherein step (c) comprises connecting said one of said users with other users who are members of the specified organization.

6. The method of claim 5, wherein at least some of said other users are selected to come from different academic institutions from said one of said users.

7. The method of claim 4, wherein the method includes receiving information, from said one of said users, concerning a residential facility in which said one of said users lives, and wherein step (c) comprises connecting said one of said users with other users who live in a same residential facility.

8. The method of claim 4, wherein the method includes receiving information, from said one of said users, concerning a location from which said one of said users originates, and wherein step (c) comprises connecting said one of said users with other users who have originated from a same location.

9. The method of claim 4, wherein the method includes receiving information, from said one of said users, concerning an academic field, and wherein step (c) comprises connecting said one of said users with other users who have a connection with said academic field.

10. The method of claim 4, wherein step (a) includes storing information about courses currently being taken by each user, and wherein step (c) comprises connecting said one of said users to others of said users who are taking a specified course currently being taken by said one of said users.

11. A method of providing on-line assistance to persons having an affiliation with an academic institution, comprising:
a) receiving information about a plurality of users, each of said plurality of users having an affiliation with an academic institution, and storing said information in a memory of a host computer,
b) accepting, from one of said plurality of users, a specification of a location of origin, and
c) providing a list of users, to said one of said plurality of users, who have an association with said location of origin.

12. The method of claim 11, further comprising providing an email connection to any one of said list of users.

13. A method of providing on-line assistance to persons having an affiliation with an academic institution, comprising:
a) receiving information about a plurality of users, each of said plurality of users having an affiliation with an academic institution, and storing said information in a memory of a host computer,
b) accepting, from one of said plurality of users, a specification of an academic field, and
c) providing a list of users, to said one of said plurality of users, who have an association with said academic field.

14. The method of claim 13, further comprising providing an email connection to any one of said list of users.

15. A method of providing on-line assistance to persons having an affiliation with an academic institution, comprising:
a) receiving information about a plurality of users, each of said users having an affiliation with an academic institution, and storing said information in a memory of a host computer,
b) storing, in the memory of the host computer, documents pertaining to courses taught at at least one academic institution,
c) accepting a query from one of said plurality of users concerning a course at an academic institution, and
d) providing at least some of the documents, stored in step (b), and associated with the course specified in step (c), to said one of said plurality of users.

16. The method of claim 15, wherein step (b) is preceded by the step of accepting, from any of said plurality of users, documents pertaining to courses taught at at least one academic institution.

17. The method of claim 16, wherein said documents are selected from the group consisting of research papers, assignments, and lecture notes.

18. A method of providing on-line assistance to persons having an affiliation with an academic institution, comprising:
a) receiving information about a plurality of users, each of said plurality of users having an affiliation with an academic institution, and storing said information in a memory of a host computer,
b) storing, in the memory of the host computer, a list of persons who wish to employ others graduating from a particular academic institution,
c) accepting, from one of said plurality of users, a specification of an academic institution, and
d) providing a list, to said one of said plurality of users, of persons whose names were stored in step (b), and who wish to employ others graduating from the academic institution specified in step (c).

19. A method of providing on-line assistance to persons having an affiliation with an academic institution, comprising:
a) receiving information about a plurality of users, each of said plurality of users having an affiliation with an academic institution, and storing said information in a memory of a host computer, said information including notices concerning courses being taken by each of said users, and
b) providing said notices to said users, wherein the notices provided to each user correspond to courses being taken by said user.

20. The method of claim 19, wherein step (a) includes receiving information about an academic institution attended by said user, and wherein the method also comprises transmitting, to said user, general notices of potential interest to persons associated with said academic institution.

21. A method of providing on-line assistance to persons having an affiliation with an academic institution, comprising:
a) enrolling a plurality of users as members of an electronic community, said users having an affiliation with an academic institution, and storing information about said users in a memory of a host computer,
b) receiving information from at least some of said users concerning merchandise being offered for sale by said at least some of said users, and making said information available to all members of said electronic community,
c) accepting bids from other users for said merchandise, and
d) matching sellers and buyers to consummate sales of said merchandise.

22. The method of claim 21, wherein said merchandise comprises tickets to events at or near an academic institution.

23. The method of claim 22, wherein said tickets comprise student-specified tickets.

24. The method of claim 23, further comprising receiving bids and offers for merchandise from persons outside said electronic community.

25. A method of compiling an electronic scrapbook for students at an academic institution, comprising:
a) enrolling a plurality of users as members of an electronic community, said users being students at an academic institution, and storing information about said users in a memory of a host computer,
b) periodically receiving information from at least some of said students, and storing said information in the memory of the host computer, and
c) retrieving all of said information received from a particular student, and making said information available to said particular student.

26. The method of claim 25, wherein step (b) includes receiving scanned photographs uploaded to the host computer from a computer operated by said at least some of said students.

27. The method of claim 25, wherein step (b) includes receiving scanned printed memorabilia uploaded to the host computer from a computer operated by said at least some of said students.

28. A method of providing on-line assistance to students at an academic institution, comprising:
a) receiving information about a plurality of students, said information including information about an academic institution attended by each of said students, and storing said information in a memory of a host computer,
b) storing, in the memory of the host computer, information about at least one merchant offering goods or services in a vicinity of an academic institution,
c) accepting, from at least one of said students, a list containing at least one merchant whose offerings are of interest to said at least one of said students, and
d) providing, to said at least one of said students, information about promotions offered by all merchants appearing on said list.

29. The method of claim 28, wherein the information provided in step (d) includes a personalized discount coupon.

30. A system for providing on-line assistance to persons having an affiliation with an academic institution, comprising:
a) a programmed computer having a memory, the memory containing information about a plurality of users, each of said plurality of users having an affiliation with an academic institution, wherein said information includes data on courses taken by each of said plurality of users,
b) the computer being programmed to accept a query, from one of said plurality of users, concerning a particular course at an academic institution, and
c) the computer comprising means for providing a name of at least one person who has taken or is taking said particular course at said academic institution, so as to allow said one of said plurality of users to contact said at least one person.

31. The system of claim 30, wherein the computer comprises means for providing on-line tutoring to said users, the on-line tutoring being provided by a person identified by the computer in response to a query from a user.

32. The system of claim 30, wherein the computer comprises means for forming an on-line study group having members including said one of said plurality of users and said at least one person located by the computer, the computer comprising means for enabling on-line communication among members of the study group concerning the course specified by said one of said plurality of users.

33. A system for providing on-line assistance to persons having an affiliation with an academic institution, comprising:
a) a programmed computer having a memory, the memory containing information about a plurality of users, wherein said users have an affiliation with an academic institution,
b) the computer being programmed to accept a request from one of said users for communication with others of said users, and
c) the computer comprising means for connecting said one of said users to others of said users so as to permit real-time on-line communication between said one of said users and said others of said users.

34. The system of claim 33, wherein the computer is programmed to accept a specification of a particular organization, and wherein the computer is programmed to connect said one of said users with other users who are members of the specified organization.

35. The system of claim 34, wherein at least some of said other users are selected to come from different academic institutions from said one of said users.

36. The system of claim 33, wherein the computer is programmed to receive information, from said one of said users, concerning a residential facility in which said one of said users lives, and wherein the computer is programmed to connect said one of said users with other users who live in a same residential facility.

37. The system of claim 33, wherein the computer is programmed to receive information, from said one of said users, concerning a location from which said one of said users originates, and wherein the computer comprises means for connecting said one of said users with other users who have originated from a same location.

38. The system of claim 33, wherein the computer is programmed to receive information, from said one of said users, concerning an academic field, and wherein the computer comprises means for connecting said one of said users with other users who have a connection with said academic field.

39. The system of claim 33, wherein the memory contains information about each course currently being taken by each user, wherein the computer comprises means for connecting said one of said users to others of said users who are taking a same specified course as said one of said users.

40. A system for providing on-line assistance to persons having an affiliation with an academic institution, comprising:
a) a programmed computer having a memory, the memory containing information about a plurality of users, each of said plurality of users having an affiliation with an academic institution,
b) the computer being programmed to accept, from one of said plurality of users, a specification of a location of origin, and
c) the computer comprising means for providing a list of users, to said one of said plurality of users, who have an association with said location of origin.

41. The system of claim 40, wherein the computer comprises means for providing an email connection to any one of said list of users.

42. A system for providing on-line assistance to persons having an affiliation with an academic institution, comprising:
a) a programmed computer having a memory, the memory containing information about a plurality of users, each of said plurality of users having an affiliation with an academic institution,
b) the computer being programmed to accept, from one of said plurality of users, a specification of an academic field, and
c) the computer comprising means for providing a list of users, to said one of said plurality of users, who have an association with said academic field.

43. The system of claim 42, wherein the computer comprises means for providing an email connection to any one of said list of users.

44. A system for providing on-line assistance to persons having an affiliation with an academic institution, comprising:
a) a programmed computer having a memory, the memory containing information about a plurality of users, each of said users having an affiliation with an academic institution,
b) the memory also containing documents pertaining to courses taught at at least one academic institution,
c) the computer being programmed to accept a query from one of said plurality of users concerning a course at an academic institution, and
d) the computer comprising means for providing at least some of the documents, stored in the memory of the computer, and associated with a course specified by said one of said plurality of users, to said one of said plurality of users.

45. The system of claim 44, wherein the computer is programmed to accept, from any of said plurality of users, documents pertaining to courses taught at at least one academic institution.

46. The system of claim 45, wherein said documents are selected from the group consisting of research papers, assignments, and lecture notes.

47. A system for providing on-line assistance to persons having an affiliation with an academic institution, comprising:
a) a programmed computer having a memory, the memory containing information about a plurality of users, each of said plurality of users having an affiliation with an academic institution,
b) the memory containing a list of employers who wish to employ others graduating from a particular academic institution,
c) the computer being programmed to accept, from one of said plurality of users, a specification of an academic institution, and
d) the computer comprising means for providing a list, to said one of said plurality of users, of employers whose names are stored in the memory of the computer, and who wish to employ others graduating from a specified academic institution.

48. A system for providing on-line assistance to persons having an affiliation with an academic institution, comprising:
a) a programmed computer having a memory, the memory containing information about a plurality of users, each of said plurality of users having an affiliation with an academic institution, said information including notices concerning courses being taken by each of said users, and
b) the computer comprising means for providing said notices to said users, wherein the notices provided to each user correspond to courses being taken by said user.

49. The system of claim 48, wherein the memory of the computer includes information about an academic institution attended by said user, and wherein the computer also comprises means for transmitting, to said user, general notices of potential interest to persons associated with said academic institution.

50. A system for providing on-line assistance to persons having an affiliation with an academic institution, comprising:
a) a programmed computer having a memory, the memory containing information about a plurality of users comprising members of an electronic community, said users having an affiliation with an academic institution,
b) the computer being programmed to receive information from at least some of said users concerning merchandise being offered for sale by said at least some of said users, the computer being programmed to make said information available to all members of said electronic community,
c) the computer comprising means for accepting bids from other users for said merchandise, and
d) the computer comprising means for matching sellers and buyers to consummate sales of said merchandise.

51. The system of claim 50, wherein said merchandise comprises tickets to events at or near an academic institution.

52. The system of claim 51, wherein said tickets comprise student-specified tickets.

53. The system of claim 52, wherein the computer is programmed to receive bids and offers for merchandise from persons outside said electronic community.

54. A system for compiling an electronic scrapbook for students at an academic institution, comprising:
a) a programmed computer having a memory, the memory containing information on a plurality of users comprising members of an electronic community, said users being students at an academic institution,
b) the computer being programmed to receive, periodically, information from at least some of said students, the computer including means for storing said information in said memory, and
c) the computer comprising means for retrieving all of said information received from a particular student, and for making said information available to said particular student.

55. The system of claim 54, wherein the computer is programmed to receive scanned photographs uploaded to the computer from another computer operated by said at least some of said students.

56. The system of claim 54, wherein the computer is programmed to receive scanned printed memorabilia uploaded to the computer from another computer operated by said at least some of said students.

57. A system for providing on-line assistance to students at an academic institution, comprising:
a) a programmed computer having a memory, the memory containing information about a plurality of students, said information including information about an academic institution attended by each of said students,
b) the memory containing information about at least one merchant offering goods or services in a vicinity of an academic institution,
c) the computer being programmed to accept, from at least one of said students, a list containing at least one merchant whose offerings are of interest to said at least one of said students, and
d) the computer comprising means for providing, to said at least one of said students, information about promotions offered by all merchants appearing on said list.

58. The system of claim 57, wherein the information provided by the computer comprises a personalized discount coupon.
